(19) United States
(12) Patent Application Publication
(10) Pub. No.: US 2013/0177119 A1
(43) Pub. Date: Jul. 11, 2013

(54) CONTROL DEVICE AND NUCLEAR POWER PLANT CONTROL SYSTEM

(71) Applicants: Shinji Kiuchi, Tokyo (JP); Hironobu Shinohara, Tokyo (JP); Yasutake Akizuki, Tokyo (JP); Toshiki Fukui, Tokyo (JP); Hiroshi Shirasawa, Tokyo (JP)

(72) Inventors: Shinji Kiuchi, Tokyo (JP); Hironobu Shinohara, Tokyo (JP); Yasutake Akizuki, Tokyo (JP); Toshiki Fukui, Tokyo (JP); Hiroshi Shirasawa, Tokyo (JP)

(73) Assignee: MITSUBISHI HEAVY INDUSTRIES, LTD., Tokyo (JP)

(21) Appl. No.: 13/824,826

(22) PCT Filed: Sep. 21, 2011
(86) PCT No.: PCT/JP2011/071432

§ 371 Date: Mar. 18, 2013

(30) Foreign Application Priority Data
Sep. 30, 2010 (JP) 2010-222484

(51) Int. Cl. G21C 17/00; G21D 3/04

(52) U.S. Cl. CPC G21C 17/00; G21D 3/04
USPC 376/215

(57) ABSTRACT

A nuclear power plant control system includes control devices, and the control devices 30a and 30b each include arithmetic units that respectively execute arithmetic processing in parallel independently, based on detection results of detection units, and each output a control signal to control a countermeasure unit in accordance with an arithmetic result of the arithmetic processing, a transmission unit that sends out the control signal to the countermeasure unit, when the control signal is outputted from at least one of the arithmetic units, and a system management unit that performs control so as to inhibit the control signal outputted by the arithmetic unit as a test object from being sent out from the transmission unit while maintaining a state where the other arithmetic operation executes the arithmetic processing independently, when a test of either of the control devices is conducted.

### FIELD

The present invention relates to a control device and a nuclear power plant control system, and particularly to a control device and a nuclear power plant control system that can enhance reliability at the test time.

### BACKGROUND

A nuclear power plant, which requires high safety, includes a control system called a safety protection system in addition to a control system that controls normal operation of the plant. The safety protection system has required extremely high reliability in order that even in an unusual situation where all other control systems become inoperative, the safety protection system can sense an abnormal event to automatically start actuation of a nuclear reactor shutdown system, and engineered safety features.

In order to realize the high reliability, the safety protection system includes a plurality of systems operating independently from one another. A control device that executes various types of controls in each of the systems includes multiplexed arithmetic units in case a failure occurs in one of the arithmetic units. The multiplexed arithmetic units have a standby redundancy configuration in which one of the arithmetic units is an active system, and the other arithmetic units are standby systems (e.g., refer to Patent Literature 1).

Moreover, since the safety protection system undertakes a very important role to the nuclear power plant, testing is required. When a test of the safety protection system is required to be conducted during operation of the nuclear power plant, operation is performed, in which the plurality of systems making up the safety protection system are shut down one by one to conduct the test.

Referring to FIG. 4, a specific description will be given. In FIG. 4, a control device 90a is included in an A system, which is one of the plurality of systems making up the safety protection system. A control device 90b is included in a B system, which is one of the plurality of systems making up the safety protection system. The control device 90a includes an arithmetic unit 91 and an arithmetic unit 92 having the standby redundancy configuration, and the control device 90b includes an arithmetic unit 93 and an arithmetic unit 94 having the standby redundancy configuration.

Here, when a test of the arithmetic unit 91 is conducted during operation of the nuclear power plant, a function of the control device 90a is stopped while the control device 90b maintains a function thereof. As a result, during the test of the arithmetic unit 91, while the A system stops the function thereof, the B system maintains the function thereof, and thus, the function of the safety protection system is maintained.

### CITATION LIST

### Patent Literature

Patent Literature 1: Japanese Patent Application Laid-open No. 2003-287587

### SUMMARY

### Technical Problem

However, when the test of the safety protection system is conducted during operation of the nuclear power plant, using the conventional method as illustrated in FIG. 4, since the function of one of the systems making up the safety protection system temporarily stops, multiplicity of the safety protection system is reduced, thereby reducing the reliability.

The present invention is devised in light of the foregoing, and an object of the present invention is to provide a control device and a nuclear power plant control system that can enhance reliability at the test time.

### Solution to Problem

According to an aspect of the present invention, a control device used in a safety protection system of a nuclear power plant includes: a plurality of arithmetic units that respectively execute arithmetic processing in parallel and independently, based on a detection result of a detection unit for detecting a specific event occurring in the nuclear power plant, and each output a control signal to control countermeasure unit for taking countermeasures against the event in accordance with an arithmetic result of the arithmetic processing; a transmission unit that sends out the control signal to the countermeasure unit, when the control signal is outputted from at least one of the plurality of arithmetic units; and a control unit that performs control so as to inhibit the control signal outputted by the arithmetic unit as a test object from being sent out from the transmission unit while maintaining a state where the other arithmetic unit executes the arithmetic processing independently, when a test of one of the plurality of the arithmetic units is conducted.

Since this control device can maintain the function while carrying out the test during plant operation, the reliability at the test time can be enhanced.

According to another aspect of the present invention, a nuclear power plant control system that controls a safety protection system of a nuclear power plant includes: a detection unit for detecting a specific event occurring in the nuclear power plant; a countermeasure unit for taking countermeasures against the event; and a plurality of control devices that respectively operate independently. The control devices may each include a plurality of arithmetic units that respectively execute arithmetic processing in parallel and independently, based on a detection result of the detection unit, and each output a control signal to control the countermeasure unit in accordance with an arithmetic result of the arithmetic processing, a transmission unit that sends out the control signal to the countermeasure unit, when the control signal is outputted from at least one of the plurality of arithmetic units, and a control unit that performs control so as to inhibit the control signal outputted by the arithmetic unit as a test object from being sent out from the transmission unit while maintaining a state where the other arithmetic operation executes the arithmetic processing independently, when a test of one of the plurality of the arithmetic units is conducted.

Since this nuclear power plant control system can maintain the function while carrying out the test during plant operation, the reliability at the test time can be enhanced.

Advantageously, in the nuclear power plant control system, after the test of the arithmetic unit as the test object is completed, the control unit causes matching processing to be executed, in which a progress status of the arithmetic processing of the arithmetic unit as the test object is matched with a progress status of the arithmetic processing of the other arithmetic unit, and after the matching processing is completed, the control unit causes the plurality of arithmetic units to perform the arithmetic processing in parallel and independently.

In this aspect, since the plurality of arithmetic units perform the arithmetic processing in parallel independently after the test is completed, the reliability of the control device can be enhanced.

Moreover, in another aspect of the present invention, the control unit stops a function of outputting the control signal that the arithmetic unit as the test object has, by which the control is performed so as to inhibit the control signal outputted by the arithmetic unit as the test object from being sent out from the transmission unit.

In this aspect, since the processing of the arithmetic unit as the test object can be prevented from affecting outside, the processing of the other arithmetic unit is continued even at the test time to maintain the function of the control device, which can enhance the reliability at the test time.

### Advantageous Effects of Invention

The control device and the nuclear power plant control system according to the present invention exert the effect that the reliability can be enhanced even though a test is carried out during plant operation.

### BRIEF DESCRIPTION OF DRAWINGS

FIG. 1 is a diagram illustrating a schematic configuration of a nuclear power plant control system according to the present embodiment.

FIG. 2 is a sequence diagram illustrating operation of a control device.

FIG. 3 is a diagram illustrating one example of shift of an arithmetic cycle of arithmetic units.

FIG. 4 is a diagram illustrating operation of a conventional nuclear power plant control system at the test time.

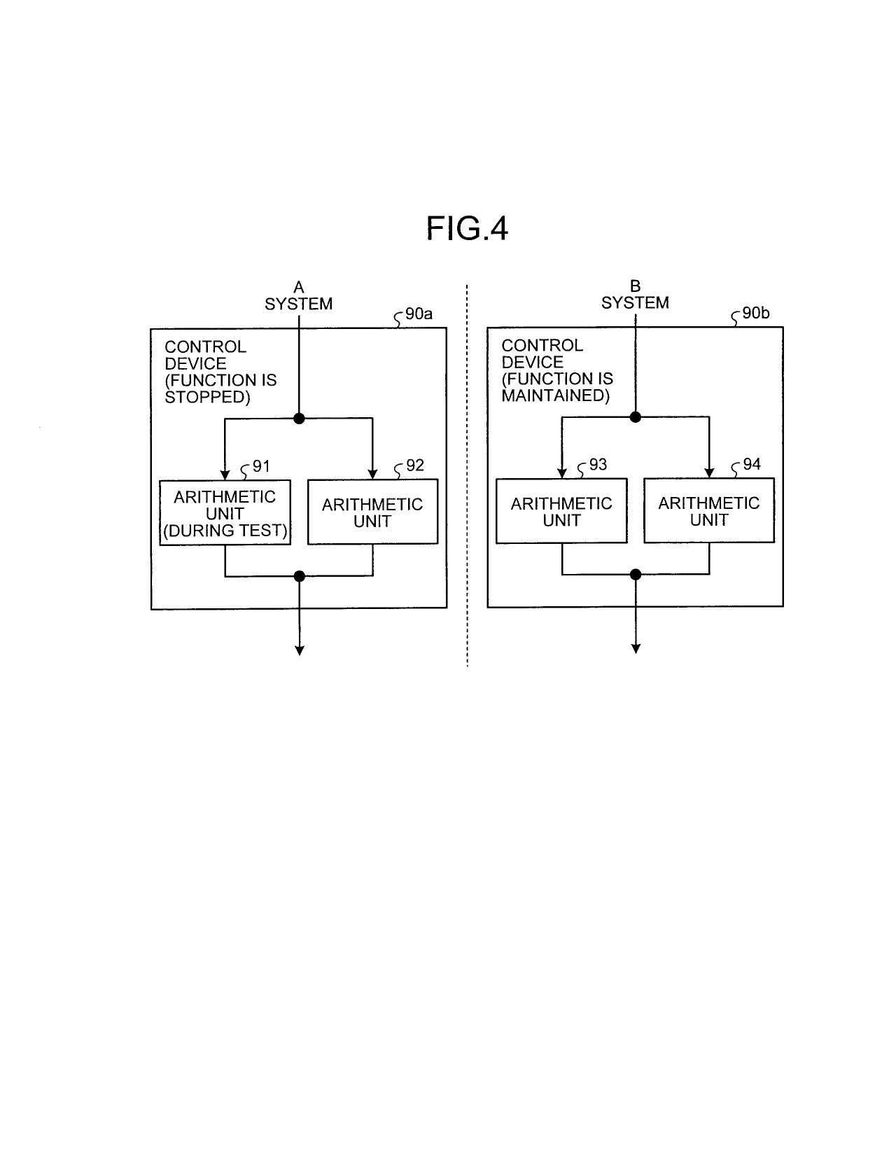

### DESCRIPTION OF EMBODIMENTS

Hereinafter, an embodiment of a control device and a nuclear power plant control system according to the present invention will be described in detail, based on the drawings. This embodiment does not limit this invention. Moreover, components in this embodiment include ones easily assumed by those in the art, substantially identical ones, and ones in a so-called equivalent range.

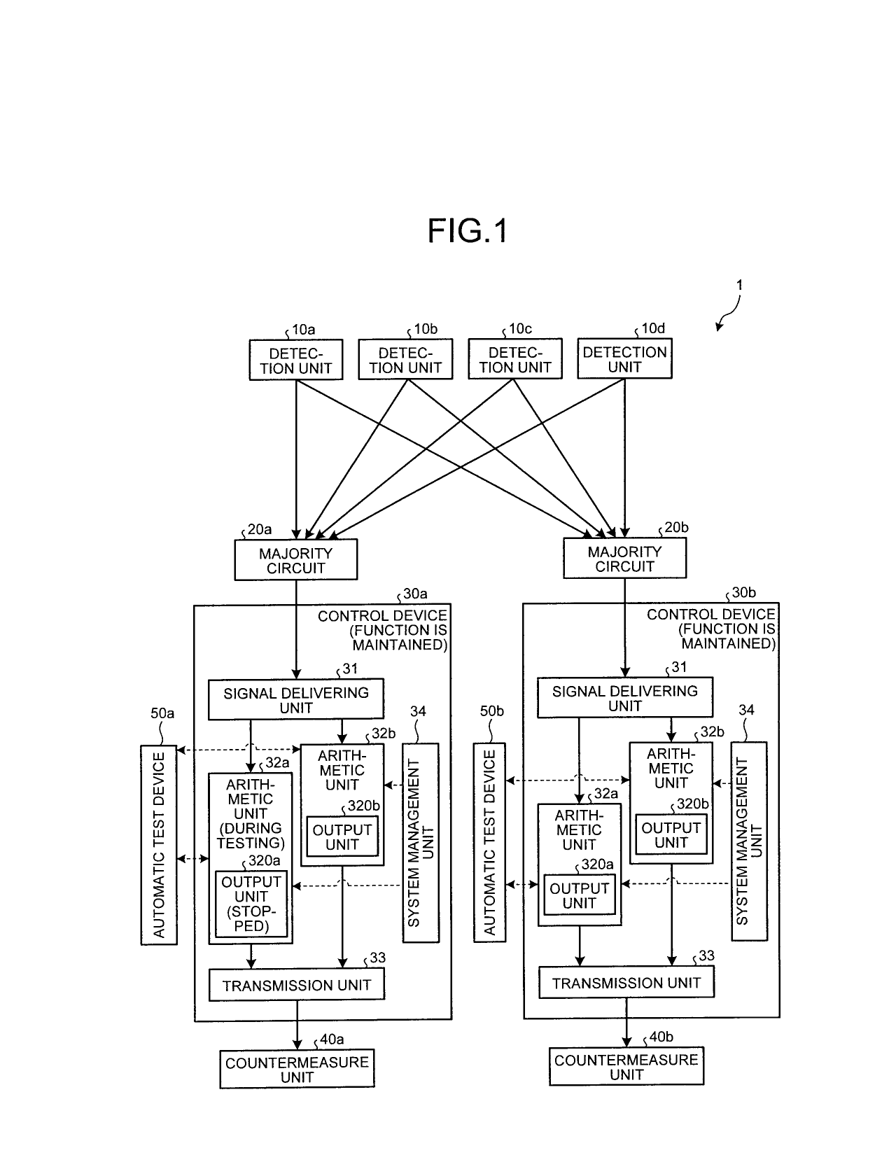

First, referring to FIG. 1, a schematic configuration of a nuclear power plant control system according to the present embodiment will be described. FIG. 1 is a diagram illustrating a schematic configuration of a nuclear power plant control system 1 according to the present embodiment. The nuclear power plant control system 1 is a control system that performs control of a safety protection system of a nuclear power plant.

As illustrated in FIG. 1, the nuclear power plant control system 1 includes a quadruplicated detection units 10a to 10d, duplicated majority circuits 20a and 20b, duplicated control devices 30a and 30b, duplicated countermeasure units 40a and 40b, and duplicated automatic test devices 50a and 50b.

The detection units 10a to 10d each detect a specific event that brings about some trouble to the operation of the nuclear power plant. The detection units 10a to 10d each have a sensor to detect a state of the nuclear power plant, and a threshold arithmetic unit to determine whether or not a detection value of the relevant sensor is a value indicating abnormality, and if the detection value of the relevant sensor is determined to be the value indicating abnormality, a detection signal is outputted to the majority circuits 20a and 20b.

When the detection signal is outputted from a predetermined number or more (e.g., 2 or more) of the detection units 10a to 10d, the majority circuit 20a transfers the detection signal to the control device 30a. When the detection signal is outputted from the predetermined number or more (e.g., 2 or more) of the detection units 10a to 10d, the majority circuit 20b transfers the detection signal to the control device 30b. The majority circuits 20a and 20b operate independently from each other.

The control device 30a determines whether or not the execution of some countermeasures is necessary, based on the detection signal transferred from the majority circuit 20a, and if it is determined that the execution of countermeasures is necessary, the control device 30a outputs a control signal instructing the execution of the countermeasures to the countermeasure unit 40a. The control device 30b determines whether or not the execution of some countermeasures is necessary, based on the detection signal transferred from the majority circuit 20b, and if it is determined that the execution of countermeasures is necessary, the control device 30b outputs a control signal instructing the execution of the countermeasures to the countermeasure unit 40b. The control devices 30a and 30b operate independently from each other.

The countermeasure unit 40a executes predetermined countermeasures, based on the control signal outputted from the control device 30a. The countermeasure unit 40b executes predetermined countermeasures, based on the control signal outputted from the control device 30b. The countermeasure units 40a and 40b operate independently from each other.

The automatic test device 50a conducts a test of the control device 30a during operation of the nuclear power plant. The automatic test device 50b conducts a test of the control device 30b during operation of the nuclear power plant. The automatic test devices 50a and 50b each conduct the test independently at specified timing.

In this manner, in the nuclear power plant control system 1, the respective units are multiplexed lest the function is lost by a signal failure, and the respective units operate independently. In the nuclear power plant control system 1 having the above-described configuration, the control devices 30a and 30b assume an important role of determining whether or not the countermeasures against the detected event is to be executed. Therefore, an internal configuration of the control devices 30a and 30b is also multiplexed.

Since the control devices 30a and 30b have a similar configuration, taking the control device 30a as one example, the internal configuration of these devices will be described. As illustrated in FIG. 1, the control device 30a includes a signal delivering unit 31, duplicated arithmetic units 32a and 32b, a transmission unit 33, and a system management unit (control unit) 34. The signal delivering unit 31 delivers the detection signal received by the control device 30a to the arithmetic unit 32a and the arithmetic unit 32b.

The arithmetic units 32a and 32b each execute predetermined arithmetic processing, based on the detection signal, and output the control signal to cause the countermeasure unit 40a to execute the predetermined countermeasures in accordance with an arithmetic result. The arithmetic unit 32a includes an output unit 320a to output the control signal, and the arithmetic unit 32b includes an output unit 320b to output the control signal. Moreover, the arithmetic units 32a and 32b each include a processor to execute the arithmetic operation, a storage device that stores data used for the arithmetic operation and the arithmetic result, and the like, and execute the same arithmetic processing in parallel independently from each other.

When the control signal is outputted from at least one of the arithmetic units 32a and 32b, the transmission unit 33 sends out the outputted control signal to the countermeasure unit 40a. That is, when both the arithmetic unit 32a and the arithmetic unit 32b normally operate, and the control signal is outputted from both the arithmetic unit 32a and the arithmetic unit 32b, the transmission unit 33 sends out the outputted control signal to the countermeasure unit 40a. Moreover, when a failure occurs in any one of the arithmetic unit 32a and the arithmetic unit 32b, and the control signal is outputted from only one of the arithmetic unit 32a and the arithmetic unit 32b, the transmission unit 33 also sends out the outputted control signal to the countermeasure unit 40a.

The system management unit 34 controls the arithmetic units 32a and 32b so that the arithmetic units 32a and 32b execute the arithmetic processing in parallel independently. Moreover, when the automatic test device 50a tests the arithmetic unit 32a, the system management unit 34 stops the function of the output unit 320a to prevent the signal outputted by the arithmetic unit 32a from being transmitted to the transmission unit 33, and operates the arithmetic unit 32b as normal. On the other hand, when the automatic test device 50a tests the arithmetic unit 32b, the system management unit 34 stops the function of the output unit 320b to prevent the signal outputted by the arithmetic unit 32b from being transmitted to the transmission unit 33, and operates the arithmetic unit 32a as normal.

As in the above-described related art, when the plurality of arithmetic units included by the control device have a standby redundancy configuration, a sensing mechanism that senses abnormality of the arithmetic unit in an active system, and a switching mechanism that switches the active system and a standby system are required, the reliability of the control device is affected by an abnormality sensing rate of the sensing mechanism and reliability of the switching mechanism.

In contrast, in the control device 30a, in place of the standby redundancy configuration, the multiplexed arithmetic units 32a and 32b are configured so as to operate in parallel independently from each other lest the function is lost even if a failure occurs in one of them. Thus, the control device 30a is not affected by the abnormality sensing rate of the sensing mechanism that senses the abnormality in the active system, and the reliability of the switching mechanism that switches between the active system and the standby system, which can realize the higher reliability.

Moreover, when one of the redundant arithmetic units is tested, the control device 30a inhibits the control signal outputted by the arithmetic unit as a test object from being sent out from the transmission unit 33 to the countermeasure unit 40a, and then, operates the other arithmetic unit as normal to maintain the function of the control device 30a. Therefore, even when a test of the safety protection system is conducted during operation of the nuclear power plant, the functions of the respective systems making up the safety protection system can be maintained, thereby enhancing reliability during the test.

In the control device including the plurality of arithmetic units with the standby redundancy configuration as well, after inhibiting the control signal outputted by the arithmetic unit as the test object from being transmitted to the countermeasure unit 40a, the other arithmetic unit can be operated as normal. However, in this case, when the arithmetic unit in the active system is tested, complicated and precise processing of switching between the active system and the standby system is required, which increases a possibility that a failure occurs, and decreases the reliability.

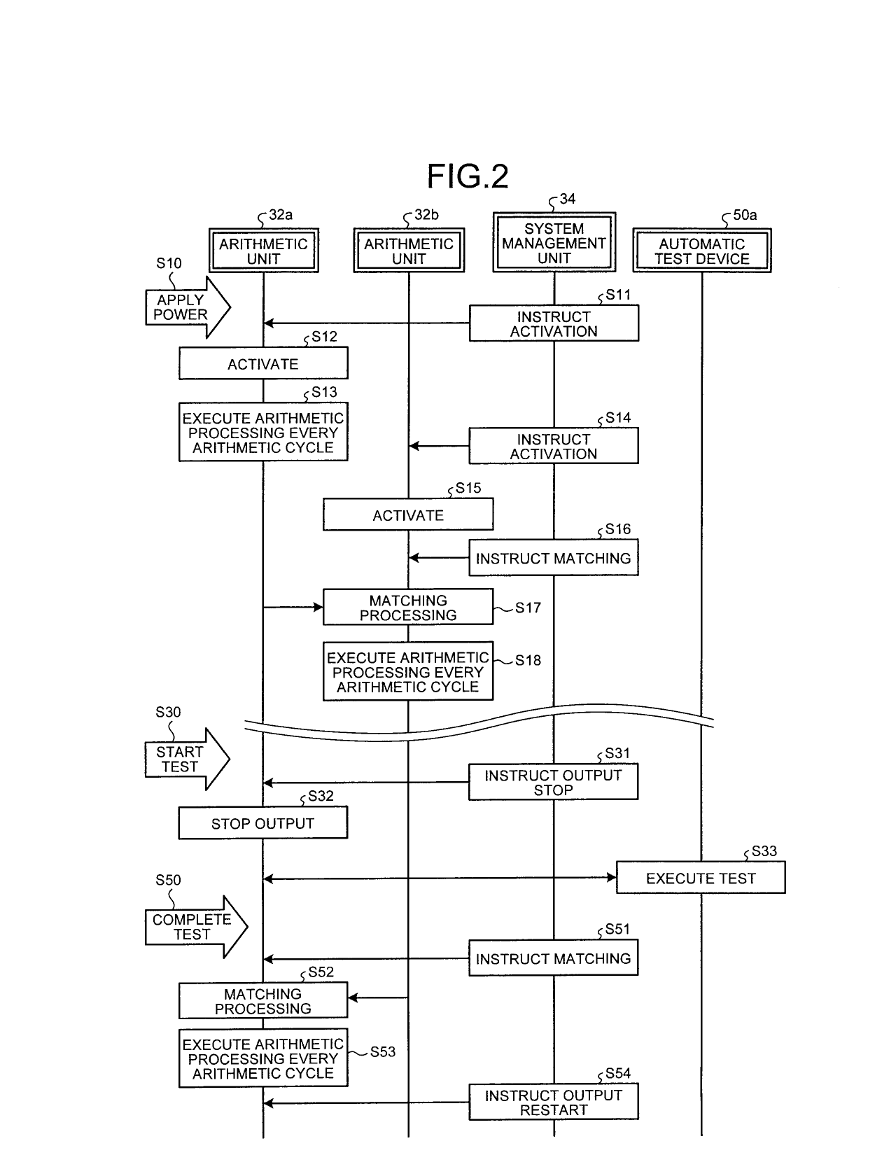

Next, operation of the control device 30a will be described with reference to FIG. 2. FIG. 2 is a sequence diagram illustrating the operation of the control device 30a. As illustrated in FIG. 2, when power is applied in step S10, the system management unit 34 instructs activation of the arithmetic unit 32a in step S11.

The arithmetic unit 32a starts the activation in accordance with the instruction in step S12. When the activation is completed, the arithmetic unit 32a executes the arithmetic processing every arithmetic cycle in step S13. The system management unit 34, after standing by for enough time to complete the activation of the arithmetic unit 32a, instructs activation of the arithmetic unit 32b in step S14. The arithmetic unit 32b starts the activation in accordance with the instruction in step S15.

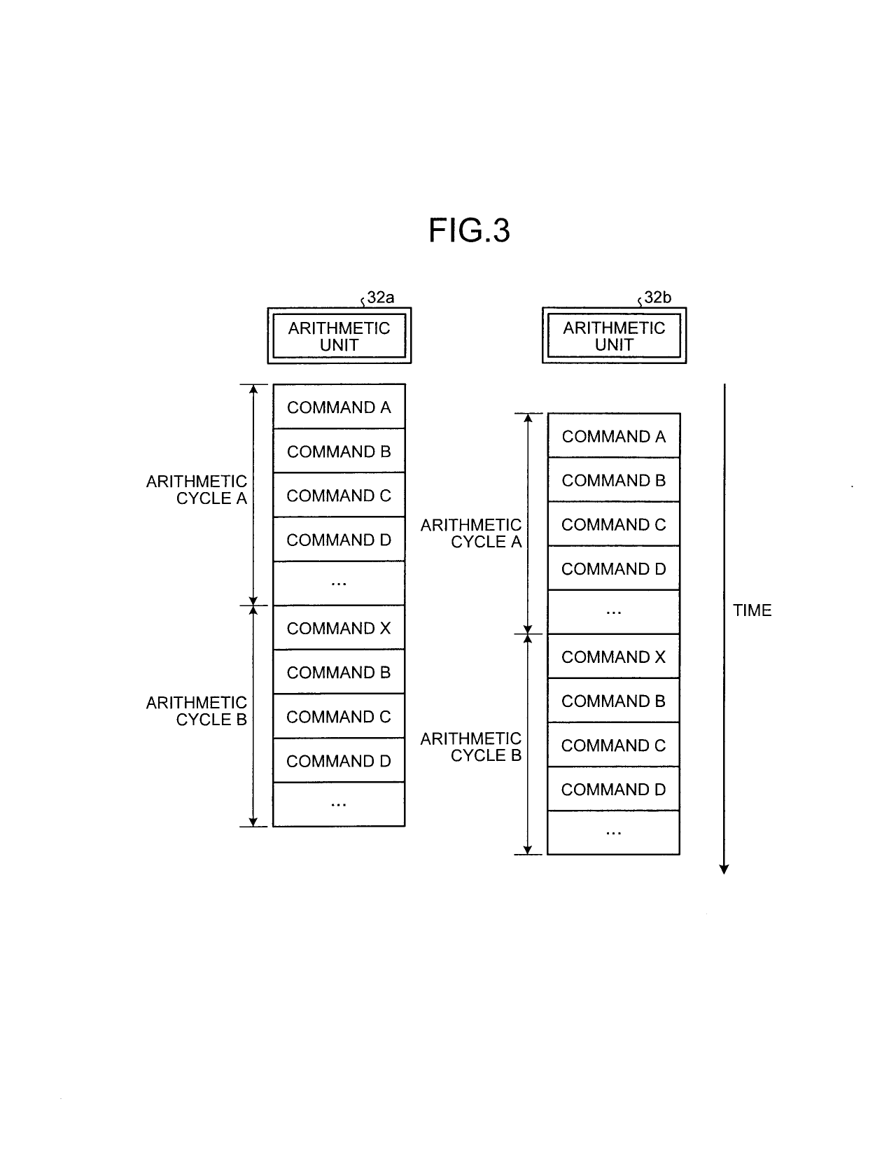

Here, the system management unit 34 may adjust activation timing of the arithmetic unit 32b so that the arithmetic cycles of the arithmetic unit 32a and the arithmetic unit 32b shift from each other. The adjustment of the activation timing by the system management unit 34 will be described with reference to FIG. 3. FIG. 3 is a diagram illustrating one example of the shift of the arithmetic cycles of the arithmetic unit 32a and the arithmetic unit 32b.

As illustrated in the example of FIG. 3, the arithmetic units 32a and 32b each execute one or a plurality of commands every arithmetic cycle of a constant length. The commands executed every arithmetic cycle include a command to self-diagnose that the safety protection system is normal, and the like in addition to a command to perform determination based on the detection signal. The arithmetic units 32a and 32b execute the same command(s) in the same order in the same arithmetic cycle.

As illustrated in the example of FIG. 3, the system management unit 34 may adjust the activation timing of the arithmetic unit 32b so that start timing of the arithmetic cycle of the arithmetic unit 32a and start timing of the arithmetic cycle of the arithmetic unit 32b shift. As a result, the arithmetic units 32a and 32b execute the same command in parallel while keeping a constant time difference. There is a possibility that the arithmetic operation by processors included by the arithmetic units 32a and 32b temporarily represents an erroneous value due to an uncertain factor such as radiation. The shift of the timing when the arithmetic unit 32a and the arithmetic unit 32b execute the command can decrease a possibility that the uncertain factor affects arithmetic results of both the arithmetic unit 32a and the arithmetic unit 32b.

When the shift between the start timing of the arithmetic cycle of the arithmetic unit 32a and the start timing of the arithmetic cycle of the arithmetic unit 32b is large, there arises a disadvantage that a difference between timing when the arithmetic unit 32a outputs the control signal to the countermeasure unit 40a and timing when the arithmetic unit 32b outputs the control signal to the countermeasure unit 40a becomes large, and thus, a magnitude of the shift is preferably shorter than the execution cycle of the command.

Referring back to FIG. 2, the system management unit 34 stands by for enough time to complete the activation of the arithmetic unit 32b, and then, in step S16, execution of matching to the arithmetic unit 32b, which has been activated subsequently, is instructed. The arithmetic unit 32b executes the matching processing in accordance with the instruction in step S17.

Specifically, the arithmetic unit 32b matches a progress status of the arithmetic processing of the arithmetic unit 32b to a progress status of the arithmetic processing of the arithmetic unit 32a already started. For example, the arithmetic unit 32b transcribes the data stored in the storage device of the arithmetic unit 32a to the storage device of the arithmetic unit 32b, and transcribes a value of a command pointer indicating a command being executed in the processor of the arithmetic unit 32a to a command pointer of the arithmetic unit 32b. The transcription of the data and the value of the command pointer may be realized by the arithmetic unit 32b reading the same from the arithmetic unit 32a, may be realized by the arithmetic unit 32a writing the same in the arithmetic unit 32b, or may be realized through the system management unit 34.

Moreover, in the case where the starting timing of the arithmetic cycle of the arithmetic unit 32a and the starting timing of the arithmetic cycle of the arithmetic unit 32b shift from each other, the system management unit 34 may cause the signal delivering unit 31 to adjust sending timing of the detection signal. In this case, specifically, the signal delivering unit 31 adjusts the timing when the detection signal is sent out so that the same detection signal can be obtained when the arithmetic units 32a and 32b execute the same command. For example, when the shift of the arithmetic cycles of the arithmetic units 32a and 32b is as illustrated in FIG. 3, the signal delivering unit 31 delays output timing of the detection signal to the arithmetic unit 32b by the magnitude of the shift of the arithmetic cycle.

After the matching processing has been completed in this manner, the arithmetic unit 32b executes the arithmetic processing every arithmetic cycle in step S18.

In this manner, the system management unit 34 matches the progress statuses of the arithmetic processing of the arithmetic unit 32a and the arithmetic unit 32b at the activation time of the control device 30a, and then operates the arithmetic unit 32a and the arithmetic unit 32b independently. This can create the state where the arithmetic unit 32a and the arithmetic unit 32b continue to execute the same command at almost the same timing while operating independently.

Thereafter, in step S30, a test of the arithmetic unit 32a is required. In this case, in step S31, the system management unit 34 instructs the stop of the function to the output unit 320a that the arithmetic unit 32a has in order to prevent the control signal outputted by the arithmetic unit 32a from being sent out from the transmission unit 33 to the countermeasure unit 40a, and the output unit 320a stops the function in step S32. At this time, the system management unit 34 allows the arithmetic unit 32b to operate as normal.

After the function of the output unit 320a stops, and the automatic test device 50a executes the test of the arithmetic unit 32a in step S33. Since the arithmetic unit 32b continues the normal operation while the function of the output unit 320a that the arithmetic unit 32a has is stopped and the test of the arithmetic unit 32a is being conducted, the control device 30a maintains the function thereof.

After the test of the arithmetic unit 32a is completed in step S50, in step S51, the system management unit 34 instructs execution of matching to the arithmetic unit 32a as a test object. The arithmetic unit 32a executes the matching processing in accordance with the instruction in step S52.

Specifically, the arithmetic unit 32a matches the progress status of the arithmetic processing of the arithmetic unit 32a to the progress status of the arithmetic processing of the arithmetic unit 32b, which is continuing the execution of the arithmetic processing. For example, the arithmetic unit 32a transcribes the data stored in the storage device of the arithmetic unit 32b to the storage device of the arithmetic unit 32a, and transcribes the value of the command pointer indicating the command being executed in the processor of the arithmetic unit 32b to the command pointer of the arithmetic unit 32a. The transcription of the data and the value of the command pointer may be realized by the arithmetic unit 32a reading the same from the arithmetic unit 32b, may be realized by the arithmetic unit 32b writing the same in the arithmetic unit 32a, or may be performed through the system management unit 34.

After the matching processing is completed in this manner, the arithmetic unit 32a executes the arithmetic processing every arithmetic cycle in step S53. The system management unit 34, in step S54, restores the function of the output unit 320a that the arithmetic unit 32a has so that the control signal outputted by the arithmetic unit 32a is sent out from the transmission unit 33 to the countermeasure unit 40a to thereby restart the output of the control signal.

In this manner, after the test of the arithmetic unit 32a is completed, the system management unit 34 matches the progress status of the arithmetic processing of the arithmetic unit 32a as the test object and the progress status of the arithmetic processing continuously executed of the arithmetic unit 32b, and then operates the arithmetic unit 32a and the arithmetic unit 32b independently. This can recreate the state where the arithmetic unit 32a and the arithmetic unit 32b continue to execute the same command at almost the same timing while operating independently.

As described above, in the present embodiment, the control device included in the nuclear power plant control system that controls the safety protection system is multiplexed, and the arithmetic unit included in the control device is further multiplexed so as to operate the respective arithmetic units in parallel independently. When a test of the arithmetic unit included in the control device is conducted, the operation of the other arithmetic unit is continued to maintain the function of the control device. This configuration makes it unnecessary to completely shut down the system when one of the systems making up the safety protection system is tested, which can enhance the reliability of the safety protection system at the test time.

The configuration of the nuclear power plant control system described in the foregoing embodiment can be arbitrarily modified in a range not departing from the gist of the present invention. For example, the multiplicity of the respective units of the nuclear power plant control system described in the foregoing embodiment may be arbitrarily modified in accordance with the required level of the reliability and the like.

While in the foregoing embodiment, when the automatic test device 50a tests the arithmetic unit 32b, the system management unit 34 stops the function of the output unit 320b in order to prevent the signal outputted by the arithmetic unit 32b from being sent out from the transmission unit 33 to the countermeasure unit 40a, another method may be used in order to prevent the signal outputted by the arithmetic unit 32b from being sent out from the transmission unit 33 to the countermeasure unit 40a.

Moreover, the nuclear power plant control system described in the foregoing embodiment can be used for control of a system other than the safety protection system and a plant other than the nuclear power plant.

### REFERENCE SIGNS LIST

1 nuclear power plant control system

10a to 10d detection unit

20a, 20b majority circuit

30a, 30b, 90a, 90b control unit

31 signal delivering unit

32a, 32b, 91 to 94 arithmetic unit

320a, 320b output unit

33 transmission unit

34 system management unit

40a, 40b countermeasure unit

1. A control device used in a safety protection system of a nuclear power plant, comprising: a plurality of arithmetic units that respectively execute arithmetic processing in parallel and independently, based on a detection result of a detection unit for detecting a specific event occurring in the nuclear power plant, and each output a control signal to control countermeasure unit for taking countermeasures against the event in accordance with an arithmetic result of the arithmetic processing; a transmission unit that sends out the control signal to the countermeasure unit, when the control signal is outputted from at least one of the plurality of arithmetic units; and a control unit that performs control so as to inhibit the control signal outputted by the arithmetic unit as a test object from being sent out from the transmission unit while maintaining a state where the other arithmetic unit executes the arithmetic processing independently, when a test of one of the plurality of the arithmetic units is conducted.

2. The control device according to claim 1, wherein after the test of the arithmetic unit as the test object is completed, the control unit causes matching processing to be executed, in which a progress status of the arithmetic processing of the arithmetic unit as the test object is matched with a progress status of the arithmetic processing of the other arithmetic unit, and after the matching processing is completed, the control unit causes the plurality of arithmetic units to perform the arithmetic processing in parallel independently.

3. The control device according to claim 2, wherein the control unit stops a function of outputting the control signal that the arithmetic unit as the test object has, by which the control is performed so as to inhibit the control signal outputted by the arithmetic unit as the test object from being sent out from the transmission unit.

4. A nuclear power plant control system that controls a safety protection system of a nuclear power plant, comprising: a detection unit for detecting a specific event occurring in the nuclear power plant; a countermeasure unit for taking countermeasures against the event; and a plurality of control devices that respectively operate independently, wherein the control devices each include a plurality of arithmetic units that respectively execute arithmetic processing in parallel and independently, based on a detection result of the detection unit, and each output a control signal to control the countermeasure unit in accordance with an arithmetic result of the arithmetic processing, a transmission unit that sends out the control signal to the countermeasure unit, when the control signal is outputted from at least one of the plurality of arithmetic units, and a control unit that performs control so as to inhibit the control signal outputted by the arithmetic unit as a test object from being sent out from the transmission unit while maintaining a state where the other arithmetic operation executes the arithmetic processing independently, when a test of one of the plurality of the arithmetic units is conducted.

5. The nuclear power plant control system according to claim 4, wherein after the test of the arithmetic unit as the test object is completed, the control unit causes matching processing to be executed, in which a progress status of the arithmetic processing of the arithmetic unit as the test object is matched with a progress status of the arithmetic processing of the other arithmetic unit, and after the matching processing is completed, the control unit causes the plurality of arithmetic units to perform the arithmetic processing in parallel and independently.

6. A control method used in a safety protection system of a nuclear power plant, comprising: executing arithmetic processing in parallel and independently by using a plurality of arithmetic units, based on a detection result of a detection unit for detecting a specific event occurring in the nuclear power plant, outputting each a control signal to control countermeasure unit for taking countermeasures against the event in accordance with an arithmetic result of the arithmetic processing; sending out the control signal to the countermeasure unit from a transmission unit, when the control signal is outputted from at least one of the plurality of arithmetic units; and performing control by using a control unit so as to inhibit the control signal outputted by the arithmetic unit as a test object from being sent out from the transmission unit while maintaining a state where the other arithmetic unit executes the arithmetic processing independently, when a test of one of the plurality of the arithmetic units is conducted.

7. A control method of a nuclear power plant control system that controls a safety protection system of a nuclear power plant, comprising: detecting a specific event occurring in the nuclear power plant by using a detection unit for; taking countermeasures against the event by using a countermeasure unit; and operating independently by using a plurality of control devices, wherein operating each include executing respectively arithmetic processing in parallel and independently by using a plurality of arithmetic units, based on a detection result of the detection unit, and outputting each a control signal to control the countermeasure unit in accordance with an arithmetic result of the arithmetic processing, sending out the control signal to the countermeasure unit from a transmission unit, when the control signal is outputted from at least one of the plurality of arithmetic units, and performing control by using a control unit so as to inhibit the control signal outputted by the arithmetic unit as a test object from being sent out from the transmission unit while maintaining a state where the other arithmetic operation executes the arithmetic processing independently, when a test of one of the plurality of the arithmetic units is conducted.
